(19) United States
(12) Patent Application Publication
(10) Pub. No.: US 2025/0374270 A1
(43) Pub. Date: Dec. 4, 2025

(54) LATE REAL-TIME PACKET TRANSMISSION

(71) Applicant: QUALCOMM Incorporated, San Diego, CA (US)

(72) Inventors: Yubing JIAN, San Diego, CA (US); Arnaud MEYLAN, San Diego, CA (US); Vishal DALMIYA, San Diego, CA (US); Vaishakh RAO, San Diego, CA (US); Yiyi ZHANG, Poway, CA (US); Ashwin MADHUR COMANDUR, San Diego, CA (US); Leena ZACHARIAS, San Jose, CA (US)

(21) Appl. No.: 18/679,152

(22) Filed: May 30, 2024

(51) Int. Cl. H04W 72/1268; H04L 1/00; H04L 1/1607; H04W 28/02; H04W 76/20

(52) U.S. Cl. CPC H04W 72/1268; H04L 1/0008; H04L 1/1642; H04W 28/0278; H04W 76/20

(57) ABSTRACT

Methods, systems, and devices for evaluation of late real-time packet data for transmission are described. A wireless device, such as a user equipment (UE), may start a first timer based on entry of a packet into a buffer at the wireless device, where the first timer is associated with a valid transmission window for the packet. The wireless device may start a second time after expiration of the first timer while the packet is still in the buffer, where the second timer is associated with a pre-discard state of the packet. The wireless device may participate in an evaluation of whether any candidate scheduled transmission exists for transmission of at least a portion of the packet and during pendency of the second timer, where participation in the evaluation is based on the packet being in the pre-discard state.

### FIELD OF TECHNOLOGY

The following relates to wireless communications, including late real-time packet transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Wireless devices, such as UEs, may transmit data to one or more other devices. The data may be time sensitive, such as for video and voice applications.

### SUMMARY

The systems, methods, and devices of this disclosure each have several innovative aspects, no single one of which is solely responsible for the desirable attributes disclosed herein.

A method for wireless communications by a wireless device (e.g., a user equipment (UE)) is described. The method may include starting a first timer based on entry of a packet into a buffer at the wireless device, where the first timer is associated with a valid transmission window for the packet, starting a second timer based on expiration of the first timer while the packet is still in the buffer, where the second timer is associated with a pre-discard state of the packet, and participating in an evaluation of whether any candidate scheduled transmission exists for transmission, during pendency of the second timer, of at least a portion of the packet, where participation in the evaluation is based on the packet being in the pre-discard state.

A wireless device for wireless communications is described. The wireless device may include one or more memories storing processor executable code, and one or more processors coupled with the one or more memories. The one or more processors may individually or collectively be operable to execute the code to cause the wireless device to start a first timer based on entry of a packet into a buffer at the wireless device, where the first timer is associated with a valid transmission window for the packet, start a second timer based on expiration of the first timer while the packet is still in the buffer, where the second timer is associated with a pre-discard state of the packet, and participate in an evaluation of whether any candidate scheduled transmission exists for transmission, during pendency of the second timer, of at least a portion of the packet, where participation in the evaluation is based on the packet being in the pre-discard state.

Another wireless device for wireless communications is described. The wireless device may include means for starting a first timer based on entry of a packet into a buffer at the wireless device, where the first timer is associated with a valid transmission window for the packet, means for starting a second timer based on expiration of the first timer while the packet is still in the buffer, where the second timer is associated with a pre-discard state of the packet, and means for participating in an evaluation of whether any candidate scheduled transmission exists for transmission, during pendency of the second timer, of at least a portion of the packet, where participation in the evaluation is based on the packet being in the pre-discard state.

A non-transitory computer-readable medium storing code for wireless communications is described. The code may include instructions executable by one or more processors to start a first timer based on entry of a packet into a buffer at the wireless device, where the first timer is associated with a valid transmission window for the packet, start a second timer based on expiration of the first timer while the packet is still in the buffer, where the second timer is associated with a pre-discard state of the packet, and participate in an evaluation of whether any candidate scheduled transmission exists for transmission, during pendency of the second timer, of at least a portion of the packet, where participation in the evaluation is based on the packet being in the pre-discard state.

In some examples of the method, wireless devices, and non-transitory computer-readable medium described herein, the packet includes real-time packet data and the valid transmission window may be a duration of time for transmission of real-time packet data.

In some examples of the method, wireless devices, and non-transitory computer-readable medium described herein, participating in the evaluation may include operations, features, means, or instructions for determining that a first candidate scheduled transmission exists during the pendency of the second timer and evaluating the first candidate scheduled transmission to determine whether the first candidate scheduled transmission may be capable of transmission of at least the portion of the packet.

In some examples of the method, wireless devices, and non-transitory computer-readable medium described herein, evaluating the first candidate scheduled transmission may include operations, features, means, or instructions for determining whether the first candidate scheduled transmission includes a quantity of padding bits that may be replaceable by at least the portion of the packet.

Some examples of the method, wireless devices, and non-transitory computer-readable medium described herein may further include operations, features, means, or instructions for transmitting at least the portion of the packet as part of the first candidate scheduled transmission based on the quantity of padding bits in the first candidate scheduled transmission being sufficient for replacement by at least the portion of the packet.

In some examples of the method, wireless devices, and non-transitory computer-readable medium described herein, transmitting at least a portion of the packet as part of the first candidate scheduled transmission may include operations, features, means, or instructions for transmitting a second portion of the packet as part of a second candidate scheduled transmission based on a quantity of padding bits in the second candidate scheduled transmission being sufficient for replacement by at least the second portion of the packet, where the second portion of the packet may be in the pre-discard state.

Some examples of the method, wireless devices, and non-transitory computer-readable medium described herein may further include operations, features, means, or instructions for transmitting at least the portion of the packet includes transmitting a set of multiple packets based on the quantity of padding bits in the first candidate scheduled transmission being sufficient for replacement by the set of multiple packets and the set of multiple packets may be in the pre-discard state.

In some examples of the method, wireless devices, and non-transitory computer-readable medium described herein, the packet may be one of a set of multiple packets in the pre-discard state and the method, apparatuses, and non-transitory computer-readable medium may include further operations, features, means, or instructions for selecting at least the portion of the packet from the set of multiple packets for transmission in the first candidate scheduled transmission may be based on a packet status, a packet identifier, a packet priority, a network condition, one or more configurations, available memory of the wireless device, or a combination thereof.

In some examples of the method, wireless devices, and non-transitory computer-readable medium described herein, a payload of the first candidate scheduled transmission may have a same data radio bearer (DRB) priority as the packet.

In some examples of the method, wireless devices, and non-transitory computer-readable medium described herein, a packet data convergence protocol (PDCP) sequence number of at least the portion of the packet may be assigned so as to avoid sequence number gaps or out-of-order sequence numbers in the first candidate scheduled transmission and subsequent scheduled transmissions.

Some examples of the method, wireless devices, and non-transitory computer-readable medium described herein may further include operations, features, means, or instructions for ignoring one or more medium access control (MAC) routing restrictions during transmission of at least the portion of the packet with the first candidate scheduled transmission.

In some examples of the method, wireless devices, and non-transitory computer-readable medium described herein, the one or more MAC routing restrictions include a subcarrier spacing restriction, a maximum physical uplink shared channel (PUSCH) allowed duration restriction, a configured grant Type restriction, or an allowed cell restriction.

In some examples of the method, wireless devices, and non-transitory computer-readable medium described herein, determining whether the first candidate scheduled transmission includes the quantity of padding bits that may be replaceable by at least the portion of the packet may include operations, features, means, or instructions for determining a priority between the packet and any pre-emptive radio link control (RLC) acknowledged mode (AM) retransmission messages that may be available to replace the quantity of padding bits.

Some examples of the method, wireless devices, and non-transitory computer-readable medium described herein may further include operations, features, means, or instructions for discarding the packet based on expiration of the second timer.

In some examples of the method, wireless devices, and non-transitory computer-readable medium described herein, during the pendency of the second timer, the packet may be not included in a buffer status report transmitted by the wireless device.

Some examples of the method, wireless devices, and non-transitory computer-readable medium described herein may further include operations, features, means, or instructions for receiving a configuration including a first duration of the first timer and a second duration of the second timer.

Some examples of the method, wireless devices, and non-transitory computer-readable medium described herein may further include operations, features, means, or instructions for adapting the second duration of the second timer based on real-time traffic type, network conditions, one or more configurations, available memory of the wireless device, or a combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports late real-time packet transmission in accordance with one or more aspects of the present disclosure.

FIG. 2 shows an example of a wireless communications system that supports late real-time packet transmission in accordance with one or more aspects of the present disclosure.

FIG. 3 shows an example of a process flow diagram that supports late real-time packet transmission in accordance with one or more aspects of the present disclosure.

FIGS. 4 and 5 show block diagrams of devices that support late real-time packet transmission in accordance with one or more aspects of the present disclosure.

FIG. 6 shows a block diagram of an action response component that supports late real-time packet transmission in accordance with one or more aspects of the present disclosure.

FIG. 7 shows a diagram of a system including a device that supports late real-time packet transmission in accordance with one or more aspects of the present disclosure.

FIGS. 8 and 9 show flowcharts illustrating methods that support late real-time packet transmission in accordance with one or more aspects of the present disclosure.

### DETAILED DESCRIPTION

In wireless communications, a user equipment (UE) may transmit packets, or packet data units (PDUs), to a network entity. In some examples, there may not be enough scheduled resources, and a packet may not be transmitted. In some examples, there may be an excess of scheduled resources, and empty ‘padding’ or resources without data, may be included as part of the uplink transmissions. The UE may be configured with a packet data convergence protocol (PCDP) that includes a PDCP discard timer, such as for real-time traffic applications. The PDCP discard timer begins when the PDCP packet arrives at a transmission buffer of the UE, and the UE discards the packet from the buffer based on the expiration of the timer. Thus, newer packets with a higher likelihood of arriving in time may be prioritized over older packets that might not arrive in time. However, in some examples, packets that may have arrived in time are discarded. Discarding older packets that could have been transmitted may result in decreased transmission quality.

Techniques described herein provide for transmitting packets that have an expired PDCP discard timer. The packets may be included in place of uplink padding. Upon expiration of the PDCP discard timer, packets may be designated as having a pre-discard status, and a second discard timer begins. The UE may perform a transmission evaluation of the packets, where the UE considers the packets for transmission. For example, the UE may prioritize the most recent packets, and include pre-discard packets in any additional space of the transport block, rather than including padding. The UE may order the packets according to priority, time received, or other factors. In some examples, the pre-discard packets may be configured to have medium access control (MAC) routing restrictions removed. After expiration of the second discard timer, the packets may be permanently discarded. Such techniques of transmitting packets in a pre-discard state may improve data throughput and quality.

Aspects of the disclosure are initially described in the context of wireless communications systems and a process flow diagram. Aspects of the disclosure are further illustrated by and described with reference to apparatus diagrams, system diagrams, and flowcharts that relate to late real-time packet transmission.

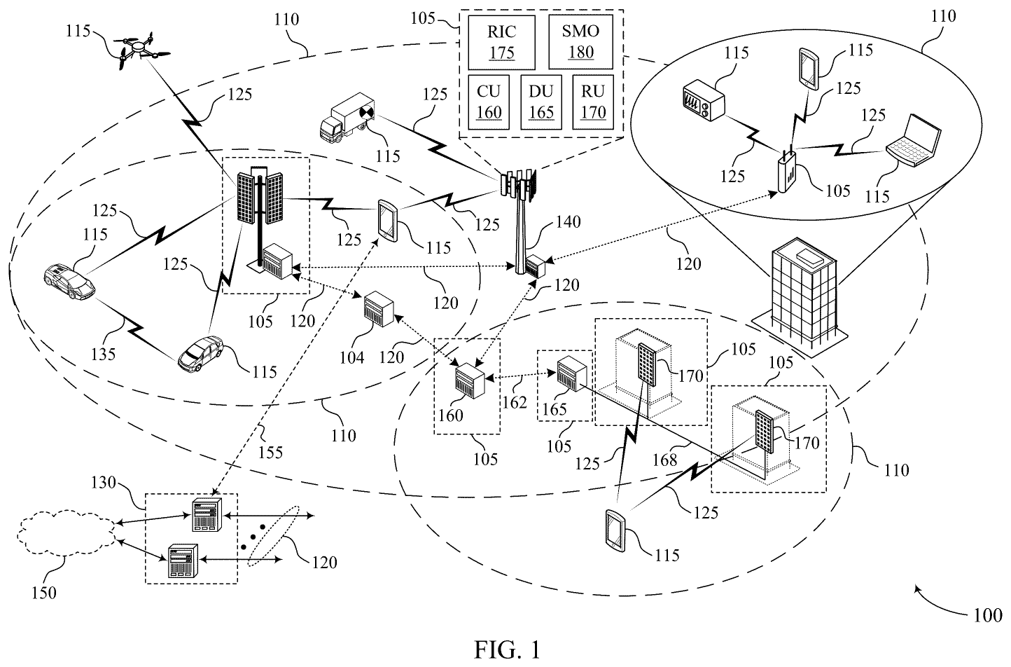

FIG. 1 shows an example of a wireless communications system 100 that supports late real-time packet transmission in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

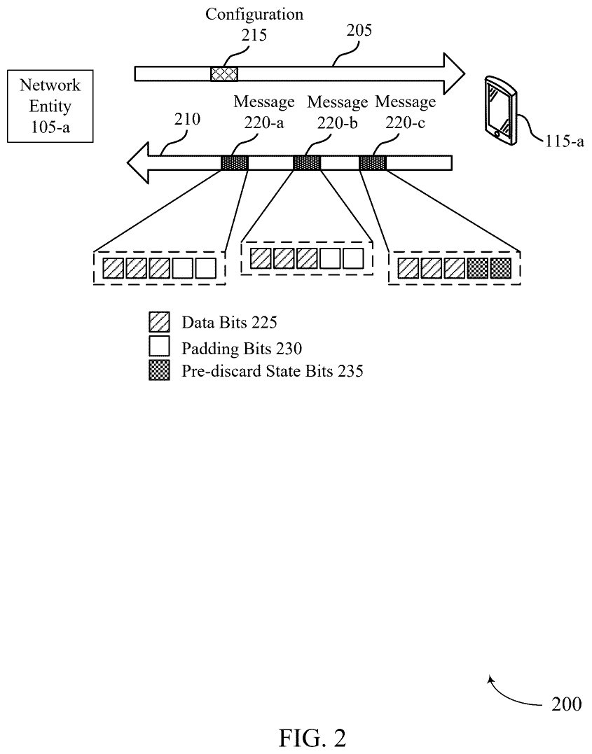

Techniques described herein provide for transmitting one or more packets that have an expired PDCP discard timer. The one or more packets may be included in place of padding, or non-data bits, of an uplink transmission. Upon expiration of the PDCP discard timer, a packet may be designated as having a pre-discard status, and a second discard timer begins. The UE 115 may perform a transmission evaluation of the pre-discard packet, where the UE 115 considers the pre-discard packet for transmissions. For example, the UE 115 may prioritize the most recent packets, and include one or more portions of pre-discard packets in any additional space of the transmission (e.g., transport block), rather than including padding. After expiration of second discard timer, if one or more portions of the pre-discard packet were not transmitted, any remaining portions of the pre-discard packet may be permanently discarded. Such techniques of including packets in a pre-discard state in real-time data transmissions may improve data throughput and quality. Techniques are further described with reference to FIGS. 2 through 9.

FIG. 2 shows an example of a wireless communications system 200 that supports late real-time packet transmission in accordance with one or more aspects of the present disclosure. The wireless communications system 200 describes the communication of late real-time packets between a network entity 105-a and a UE 115-a. The network entity 105-a may be an example of the network entity 105 as described with reference to FIG. 1, and the UE 115-a may be an example of the UE 115 as described with reference to FIG. 1. In some examples, the network entity 105-a and the UE 115-a may be examples of wireless devices.

In the example of FIG. 2, The network entity 105-a may communicate (e.g., transmit, output) with the UE 115-a via a communication link 205 (e.g., a downlink channel, a physical downlink control channel (PDCCH), a physical downlink shared channel (PDSCH), among other examples). The UE 115-a may communicate (e.g., transmit, output) with the network entity 105-a via a communication link 210 (e.g., an uplink channel, a physical uplink control channel (PUCCH), a physical uplink shared channel (PUSCH), among other examples).

The network entity 105-a may transmit a configuration 215 to the UE 115-a. The UE 115-a may transmit messages 220, such as a message 220-a, a message 220-b, and a message 220-c, to the network entity 105-a. The messages 220 may include one or more data bits 225, one or more padding bits 230, one or more pre-discard state bits 235, or a combination thereof. In some examples, the message 220-a and the message 220-b may have a combination of the data bits 225 and the padding bits 230, and the message 220-a may have a combination of the data bits 225 and the pre-discard state bits 235. In some examples, the data bits 225 may be real-time data, and the pre-discard state bits 235 may be late real-time data (e.g., pre-discard state packet) that is transmitted in place of the padding bits 230. In some examples, the pre-discard state bits 235 may be one or more portions of one or more pre-discard state packets. In some examples, the pre-discard state bits 235 may include entire packets.

Real-time packets, which may include one or more data bits 225, may be used for data for real-time applications, such as for voice or video calling. In some examples, real-time packets may be lost. Such losses may be a result of PDCP uplink discard. For example, the PDCP sender may delete real-time packets that have buffered for too long, such as based on a PDCP discard timer configuration. That is, a packet may be discarded after expiration of a PDCP discard timer. In some examples, discarded packets are not recoverable. In some applications, uplink padding is used for transmissions. Techniques described herein provide for replacing uplink padding with real-time packets that would otherwise be discarded, but that still could be transmitted and arrive in time.

The PDCP may discard uplink packets when the PDCP discard timer expires. The timer may begin when a PDCP packet data unit, or packet, arrives at the UE 115-a. The discard timer may be configured by the network. Discarding packets after a period of time may prevent packets that are not likely to arrive in time from being transmitted, allowing for newer packets to reach the destination in time. However, the PDCP discard timer may result in the discard of packets that could arrive in time. Thus, real-time packets may be unnecessarily discarded.

Using uplink padding to transmit PDCP packets that would have been discarded, but would arrive in time, may result in higher throughput and increased quality. For example, internet protocol multimedia subsystem (IMS) traffic, such as for voice over new radio (VoNR), may have a relatively short discard timer and the packets may be more likely to be discarded. The packet size of IMS traffic may be small enough to be transmitted via uplink grant padding, such that IMS traffic may be an application for replacing uplink padding with real-time packets. Such techniques may provide an increase in packet success delivery rate without increasing transmission resource use.

The UE 115-a may begin the PDCP discard timer, or a first timer. After expiration of the first timer, the UE 115-b may begin a second time and the packet enters a pre-discard state. During the second timer, while the packet is in the pre-discard state, the UE 115-a may perform an evaluation process to determine whether to transmit the packet. In some examples, the UE 115-a may transmit one or more portions of the packet in the pre-discard state in place of uplink padding. At the expiration of the second timer, the UE 115-a may discard the portions of the packet that were in the pre-discard state and were not transmitted.

In some examples, the UE 115-a may have one or more second timers for one or more packets, which may be considered for transmission. The UE 115-b may transmit multiple portions of multiple packets, or entire packets, that are in the pre-discard state. For example, the UE 115-a may transmit one or more pre-discard state bits 235 that may be from one or more packets in the pre-discard state.

The UE 115-a may perform an evaluation process to determine whether to transmit the packet (e.g., or a portion of the packet) when the packet is in the pre-discard state. The UE 115-a may determine if there is space in the transport block. That is, the UE 115-a may determine if there are padding bits 230. If there are one or more padding bits 230, the UE 115-a may include one or more pre-discard state bits 235 of one or more packets in the pre-discard state (e.g., pre-discard packets).

The UE 115-a may prioritize the most recent packets (e.g., uplink layer 2 packets) in the transport block, or transmission. For example, the UE 115-a may include one or more data bits 225 of the most recent packets prior to including the pre-discard state bits 235 of the packets in the pre-discard state. The most recent packets may be in a buffer state prior to the expiration of the PDCP discard timer (e.g., first timer).

In some examples, there may be multiple pre-discard packets eligible for transmission. The UE 115-a may select one or more portions of the multiple packets based on various factors, such as packet status, packet sequence number, packet identifier, network metrics, and UE 115-a factors. Network metrics may include end-to-end network conditions and RRC configurations. UE 115-a factors may include UE 115-a status, such as available memory.

In some examples, the pre-discard packets may have the same data radio bearer (DRB) priority as the buffer packets without expired PDCP discard timers. For example, the pre-discard packets may be the priority of the default DRB. In such examples, the pre-discard packets may be placed before or after the most recent packets, or buffer packets, in the transport block.

The UE 115-a may transmit a buffer status report (BSR) to indicate an amount of data that the UE 115-a has ready to transmit. In some examples, the BSR report may include buffer packets, but not include pre-discard packets.

The UE 115-a may have multiple packets, some of which are in the pre-discard state and some of which are in the buffer state (e.g., most recent, fresh). The buffer packets and pre-discard packets may be ordered (e.g., or reassigned) to prevent PDCP sequence number holes or out-of-window PDCP sequence numbers. For example, the UE 115-a may order the packets according to an allocated PDCP sequence number. Preventing PDCP sequence number holes may avoid latency associated with PDCP reordering timer. The PDCP may send packets out of order according to their internet protocol (IP) identifier. The UE 115-a may perform Robust Header Compression (RoHC) for real-time traffic. In some examples, RoHC decompression may fail at the network entity 105-a, such as if the UE 115-a sends out-of-order RoHC packets. To mitigate the potential decompression failure issue, the UE 115-a may recompress pre-discard packets with the same RoHC profile of different RoHC profiles (e.g., profile 0 or 2), use more bits for compressed SN to increase tolerance of out of order RoHC packets, clear all pending pre-discard packets after including any pre-discard packets in padding without recompression of any pre-discard packets, or a combination thereof.

Table 1 describes an example of how to transmit packets to avoid PDCP sequence number holes. As shown in Table 1, the UE 115-a have 8 packets, each with a corresponding IP packet sequence number (e.g., a first packet has an IP sequence number of 1, a second packet has an IP sequence number of 2, etc.). Packets 1 through 4 may be in the pre-discard state (e.g., pre-discard packets). Packets 5 and 6 may be in the buffer state (e.g., buffer packets) and received prior to a first PUSCH transmission, or transport block. Packets 7 and 8 may arrive after the first PUSCH transmission.

TABLE 1

| | | | | | Buffer State: | | Buffer State: | |
|---|---|---|---|---|---|---|---|---|
| | | | | | Prior to the 1st | | After the 1st | |
| | | | | | PUSCH | | PUSCH | |
| State | Pre-discard State | | | | transmission | | transmission | |
| IP Packet | 1 | 2 | 3 | 4 | 5 | 6 | 7 | 8 |
| Sequence | | | | | | | | |
| Number | | | | | | | | |

As described in Table 2, The UE 115-a may allocate packets for the first PUSCH transmission, and then a second PUSCH transmission. The UE 115-a may assign sequential PDCP sequence numbers, regardless of IP packet sequence number. For example, as shown in Table 2, when transmitting the first PUSCH transmission, the UE 115-a may prioritize packets in the buffer state and then include packets in the pre-discard state. The UE 115-a may include the buffer packets 5 and 6, which are the most recent packets at the time of evaluation of transmission for the first PUSCH transmission. The UE 115-a may identify that there is space in the first PUSCH transmission after inclusion of the buffer packets 5 and 6, and may also include packets 1 and 2 from the pre-discard state. The UE 115-a may assigned PDCP sequence numbers according to transmission order, regardless of packet status and IP sequence number. For example, if the UE 115-a had already transmitted packets with PDCP sequences numbers from 1-9, the UE 115-a may begin numbers the packets of the first PUSCH transmission with 10. Thus, packet 5 may be allocated a PDCP sequence number of 10, the packet 6 may be allocated a PDCP sequence number of 11, the packet 1 may be allocated a PDCP sequence of 12, and the packet 2 may be allocated a PDCP sequence number of 13.

After the first PUSCH transmission, the UE 115-a may transmit the second PUSCH transmission. As shown in Table 2, the second PUSCH transmission may have packets with PDCP sequence numbers continuing from the first PUSCH transmission. That is, the PDCP sequence numbers may begin at 14. The UE 115-a may include packets 7 and 8, the most recent packets in the buffer, having arrived after the first PUSCH transmission. The UE 115-a may then include any packets in the pre-discard state, such as packets 3 and 4.

TABLE 2

| | | | | | |
|---|---|---|---|---|---|
| First PUSCH | IP Packet | 5 | 6 | 1 | 2 |
| Transmission | sequence | | | | |
| | Allocated | 10 | 11 | 12 | 13 |
| | PDCP | | | | |
| | Sequence | | | | |
| | Number | | | | |
| Second | IP Packet | 7 | 8 | 3 | 4 |
| PUSCH | sequence | | | | |
| Transmission | Allocated | 14 | 15 | 16 | 17 |
| | PDCP | | | | |
| | Sequence | | | | |
| | Number | | | | |

While described with reference to packets, the techniques as described herein and with reference to Table 1 and Table may also apply to portions of packets. For example, the UE 115-a may transmit a first portion of a packet in the pre-discard state as part of the first PUSCH transmission and a second portion of the same packet as part of the second PUSCH transmissions. Thus, portions of packets in the pre-discard state may be considered multiple times for transmission prior to the expiration of the second timer. Similarly, upon expiration of the second timer, none, all, or portions of a packet may be discarded.

In some examples, MAC routing restrictions may be removed for pre-discard packets. For example, various MAC routing configuration that may be removed may include a configuration that sets the allowed subcarrier spacings for transmission (e.g., thatallowedSCS-List), a configuration that sets the maximum PUSCH duration allowed for transmission (e.g., maxPUSCH-Duration), a configuration that sets whether a configured grant Type 1 can be used for transmission (e.g., configuredGrantType 1 Allowed), a configuration that sets the allowed cells for transmission (e.g.,), or a combination thereof.

Mapping restrictions may be removed for pre-discard packets (e.g., allowedServingCells). For example, pre-discard packets may be transmitted via a secondary component carrier if an uplink grant is available, even if the MAC configuration only allows transmission via the primary component carrier.

In some examples, evaluating packets for transmission may include the priority of any pre-emptive radio link (RLC) acknowledge mode (AM) retransmission messages. For example, the UE 115-a may compare priority of buffer packets, pre-discard packets, and pre-discard packets with pre-emptive RLC AM retransmissions. In some examples, DRB priority may affect the priority of the packets. For example, if voice has higher priority than an AM bearer, then the pre-discard packets may have a higher priority than the RLC AM retransmission packets.

The configuration 215 may include the PDCP timer (e.g., first timer) and the second discard timer. In some examples, the configuration 215 may include an updated second discard timer, or the network entity 105-a may transmit an additional configuration with an updated second discard timer. The UE 115-a may adjust the second discard timer based on the updated configuration. In some examples, the UE 115-a may autonomously adjust the second discard timer without explicit direction. The network entity 105-a and the UE 115-a may update the second discard timer based on real-time traffic type, network metrics (e.g., end-to-end network condition, RRC configuration), UE 115-a status (e.g., available memory), or a combination of factors.

In some examples, techniques described herein may apply to any real-time traffic, such as voice, video, and internet priority queue. In some examples, machine learning may be applied to determine when the packet is in a pre-discard state and when the packet is discarded.

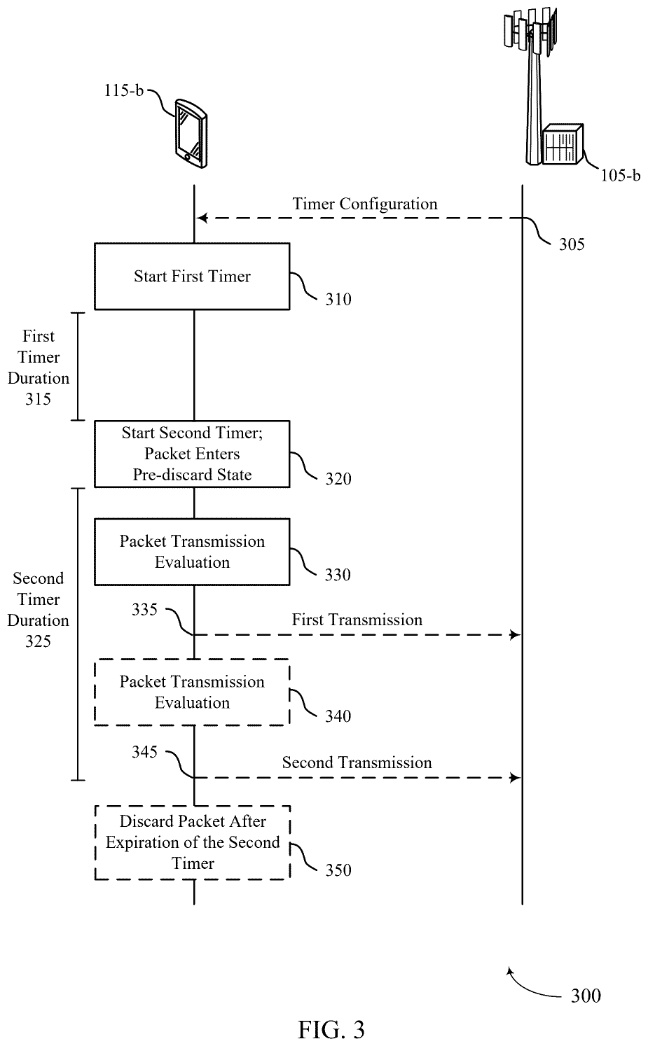

FIG. 3 shows an example of a process flow diagram 300 that supports late real-time packet transmission in accordance with one or more aspects of the present disclosure. The process flow diagram 300 describes the evaluation of a packet for transmission between a UE 115-b and a network entity 105-b, each of which may be an example of the UE 115 and the network entity 105 as described herein. Alternative examples of the following process flow may be implemented, where some steps are performed in a different order than described or are not performed at all. In some cases, steps may include additional features not mentioned below, or further steps may be added. While described with reference to a packet, the techniques described may apply to multiple packets and portions of packets.

At 305, the network entity 105-b may transmit, to the UE 115-b (e.g., the wireless device), a timer configuration. The configuration may include a first duration of the first timer (e.g., a first timer duration 315, PDCP discard timer) and a second duration of the second timer (e.g., a second timer duration 325). In some examples, the UE 115-b may adapt the second duration of the second timer based on real-time traffic type, network conditions, one or more configurations, available memory of the wireless device, or a combination thereof. For example, the UE 115-a may receive a configuration updating the second timer.

At 310, the UE 115-b (e.g., the wireless device) may start a first timer (e.g., PDCP discard timer) based on entry of a packet into a buffer at the UE 115-b (e.g., the wireless device), wherein the first timer is associated with a valid transmission window for the packet. The packet may include real-time packet data, where the valid transmission window is a duration of time for transmission of real-time packet data. The valid transmission window may be the first timer duration 315.

The first timer duration 315 may span from the start of the first timer to the start of the second timer. During the first timer duration 315, the packet may be in a buffer state, and may have a high priority for transmission.

At 320, the UE 115-b may start a second timer based on expiration of the first timer while the packet is still in the buffer, where the second timer is associated with a pre-discard state of the packet.

The second timer duration 325 may span from the start of the second timer, where the packet enters a pre-discard state, to the expiration of the second timer. During the second timer duration 325, the UE 115-b may evaluate the packet for transmission.

At 330, the UE 115-b may participate in an evaluation of whether any candidate scheduled transmission exists for transmission during pendency of the second timer. The UE 115-b may evaluate at least a portion of the packet, where participation in the evaluation is based on the packet being in the pre-discard state.

The evaluation may include determining that a first candidate scheduled transmission exists during the pendency of the second timer, and evaluating the first candidate scheduled transmission to determine whether the first candidate scheduled transmission is capable of transmission of at least the portion of the packet.

In some examples, evaluating the first candidate scheduled transmission may include determining whether the first candidate scheduled transmission includes a quantity of padding bits that are replaceable by at least the portion of the packet.

In some examples, the packet is one of multiple of packets in the pre-discard state, and the UE 115-b may select at least the portion of the packet from the multiple packets. In some examples, the UE 115-b may select multiple portions from multiple packets, or may select entire packets. The UE 115-b may select at least the portion of the packet for transmission in the first candidate scheduled transmission based on a packet status, a packet identifier, a packet priority, a network condition, one or more configurations, available memory of the wireless device, or a combination thereof.

The UE 115-b may determine whether the first candidate scheduled transmission includes the quantity of padding bits that are replaceable by at least the portion of the packet by determining a priority between the packet and any pre-emptive radio link control (RLC) acknowledged mode (AM) retransmission messages that are available to replace the quantity of padding bits. In some examples, the payload of the first candidate scheduled transmission has a same data radio bearer (DRB) priority as the packet.

In some examples, during the pendency of the second timer, the packet is not included in a buffer status report transmitted by the wireless device (e.g., the UE 115-b).

At 335, the UE 115-b may transmit at least the portion of the packet as part of the first candidate scheduled transmission based on the quantity of padding bits in the first candidate scheduled transmission being sufficient for replacement by at least the portion of the packet.

In some examples, transmitting at least the portion of the packet includes transmitting multiple packets based on the quantity of padding bits in the first candidate scheduled transmission being sufficient for replacement by the multiple packets, where the multiple packets are in the pre-discard state.

In some examples, a PDCP sequence number of at least the portion of the packet is assigned so as to avoid sequence number gaps or out-of-order sequence numbers in the first candidate scheduled transmission and subsequent scheduled transmissions.

In some examples, the UE 115-b may ignore one or more MAC routing restrictions during transmission of at least the portion of the packet with the first candidate scheduled transmission. herein the one or more MAC routing restrictions include a subcarrier spacing restriction, a maximum PUSCH allowed duration restriction, a configured grant type restriction, or an allowed cell restriction.

At 340, The UE 115-b may evaluate one or more additional portions, such as a second portion, of the packet for transmission. For example, if a portion of the packet is transmitted, and a second portion remains during the pendency of the second timer duration 325, the UE 115-b may evaluate the remaining portion.

At 345, the UE 115-b may transmit a second portion of the packet as part of a second candidate scheduled transmission based at least in part on a quantity of padding bits in the second candidate scheduled transmission being sufficient for replacement by at least the second portion of the packet, where the second portion of the packet is in the pre-discard state.

At 350, the UE 115-b may discard the packet based on expiration of the second timer. The UE 115-b may discard one or more portions for the packet. For example, if the UE 115-b transmits a first portion of the packet, the UE 115-b may discard a second portion of the packet. In some examples, the UE 115-b may transmit multiple portions of the packets and discard one or more other portions of the packet. In some examples, if the packet is transmitted, the UE 115-b may not have any packet to discard.

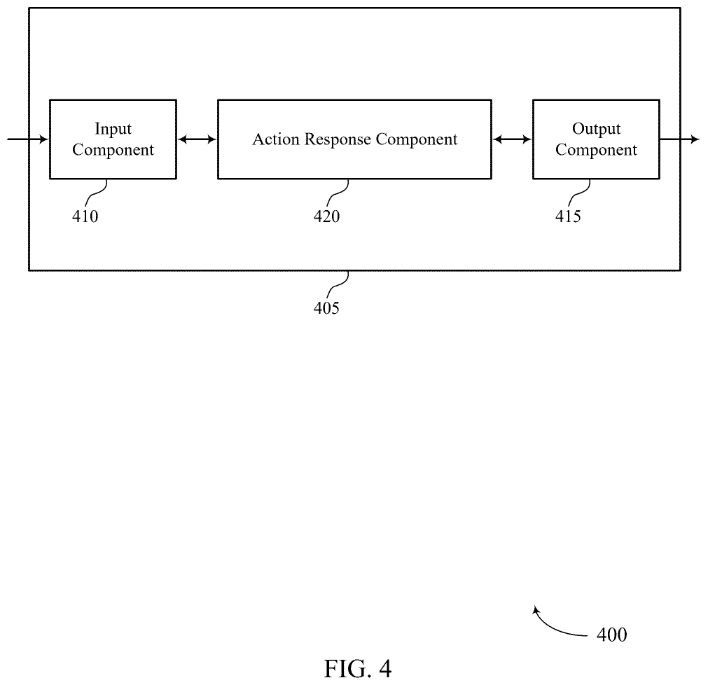

FIG. 4 shows a block diagram 400 of a device 405 (e.g., apparatus) that supports late real-time packet transmission in accordance with one or more aspects of the present disclosure. The device 405 may be an example of aspects of a wireless device as described herein. The device 405 may include an input component 410, an output component 415, and an action response component 420. The device 405, or one or more components of the device 405 (e.g., the input component 410, the output component 415, the action response component 420), may include at least one processor, which may be coupled with at least one memory, to, individually or collectively, support or enable the described techniques. Each of these components may be in communication with one another (e.g., via one or more buses).

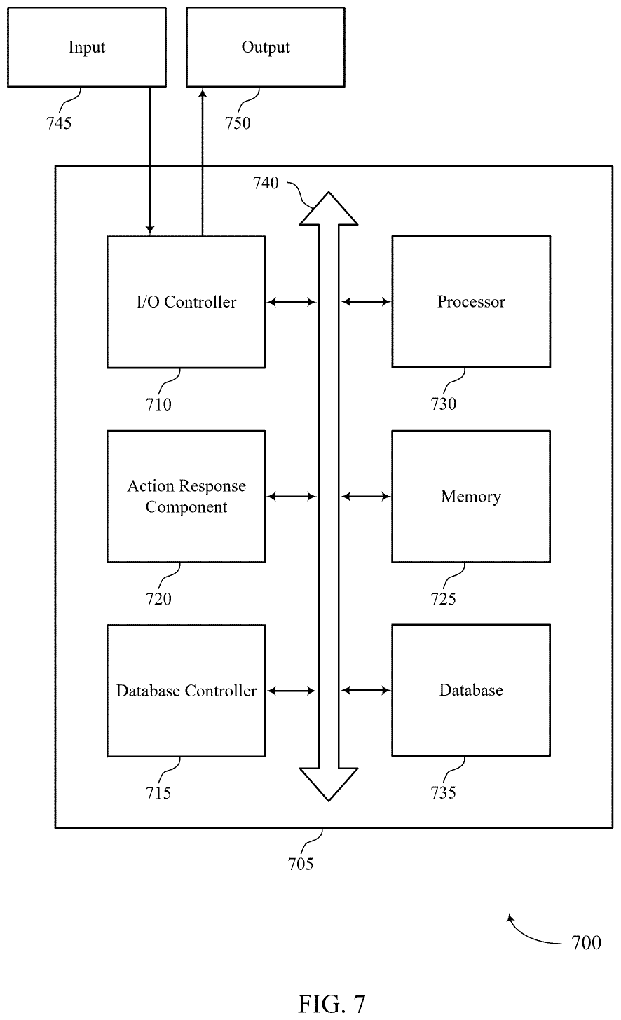

The input component 410 may manage input signals for the device 405 (e.g., apparatus). For example, the input component 410 may identify input signals based on an interaction with a modem, a keyboard, a mouse, a touchscreen, or a similar device. These input signals may be associated with user input or processing at other components or devices. In some cases, the input component 410 may utilize an operating system such as iOS®, ANDROID®, MS-DOS®, MS-WINDOWS®, OS/2®, UNIX®, LINUX®, or another known operating system to handle input signals. The input component 410 may send aspects of these input signals to other components of the device 405 for processing. For example, the input component 410 may transmit input signals to the action response component 420 to support late real-time packet transmission. In some cases, the input component 410 may be a component of an I/O controller 710 as described with reference to FIG. 7.

The output component 415 may manage output signals for the device 405. For example, the output component 415 may receive signals from other components of the device 405, such as the action response component 420, and may transmit these signals to other components or devices. In some specific examples, the output component 415 may transmit output signals for display in a user interface, for storage in a database or data store, for further processing at a server or server cluster, or for any other processes at any number of devices or systems. In some cases, the output component 415 may be a component of an I/O controller 710 as described with reference to FIG. 7.

The action response component 420, the input component 410, the output component 415, or various combinations or components thereof may be examples of means for performing various aspects of late real-time packet transmission as described herein. For example, the action response component 420, the input component 410, the output component 415, or various combinations or components thereof may be capable of performing one or more of the functions described herein.

In some examples, the action response component 420, the input component 410, the output component 415, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the action response component 420, the input component 410, the output component 415, or various combinations or components thereof may be implemented in code (e.g., as communications management software or firmware) executed by at least one processor (e.g., referred to as a processor-executable code). If implemented in code executed by at least one processor, the functions of the action response component 420, the input component 410, the output component 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the action response component 420 may be configured to perform various operations (e.g., receiving, obtaining, monitoring, outputting, transmitting) using or otherwise in cooperation with the input component 410, the output component 415, or both. For example, the action response component 420 may receive information from the input component 410, send information to the output component 415, or be integrated in combination with the input component 410, the output component 415, or both to obtain information, output information, or perform various other operations as described herein.

The action response component 420 may support wireless communications in accordance with examples as disclosed herein. For example, the action response component 420 is capable of, configured to, or operable to support a means for starting a first timer based on entry of a packet into a buffer at the wireless device, where the first timer is associated with a valid transmission window for the packet. The action response component 420 is capable of, configured to, or operable to support a means for starting a second timer based on expiration of the first timer while the packet is still in the buffer, where the second timer is associated with a pre-discard state of the packet. The action response component 420 is capable of, configured to, or operable to support a means for participating in an evaluation of whether any candidate scheduled transmission exists for transmission, during pendency of the second timer, of at least a portion of the packet, where participation in the evaluation is based on the packet being in the pre-discard state.

By including or configuring the action response component 420 in accordance with examples as described herein, the device 405 (e.g., at least one processor controlling or otherwise coupled with the input component 410, the output component 415, the action response component 420, or a combination thereof) may support techniques for late real-time packet transmission, which may result in various advantages, such as reduced processing, reduced power consumption, more efficient utilization of communication resources, etc.

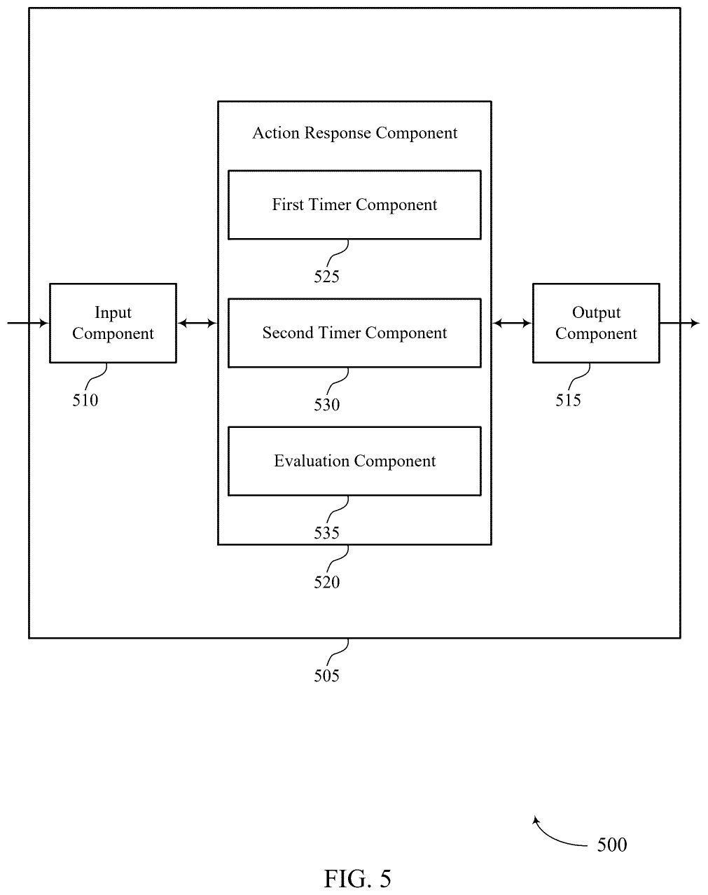

FIG. 5 shows a block diagram 500 of a device 505 (e.g., apparatus) that supports late real-time packet transmission in accordance with one or more aspects of the present disclosure. The device 505 may be an example of aspects of a device 405 or the UE 115 (e.g., a wireless device) as described herein. The device 505 may include an input component 510, an output component 515, and an action response component 520. The device 505, or one or more components of the device 505 (e.g., the input component 510, the output component 515, the action response component 520), may include at least one processor, which may be coupled with at least one memory, to support the described techniques. Each of these components may be in communication with one another (e.g., via one or more buses).

The input component 510 may manage input signals for the device 505 (e.g., apparatus). For example, the input component 510 may identify input signals based on an interaction with a modem, a keyboard, a mouse, a touchscreen, or a similar device. These input signals may be associated with user input or processing at other components or devices. In some cases, the input component 510 may utilize an operating system such as iOS®, ANDROID®, MS-DOS®, MS-WINDOWS®, OS/2®, UNIX®, LINUX®, or another known operating system to handle input signals. The input component 510 may send aspects of these input signals to other components of the device 505 for processing. For example, the input component 510 may transmit input signals to the action response component 520 to support late real-time packet transmission. In some cases, the input component 510 may be a component of an I/O controller 710 as described with reference to FIG. 7.

The output component 515 may manage output signals for the device 505. For example, the output component 515 may receive signals from other components of the device 505, such as the action response component 520, and may transmit these signals to other components or devices. In some specific examples, the output component 515 may transmit output signals for display in a user interface, for storage in a database or data store, for further processing at a server or server cluster, or for any other processes at any number of devices or systems. In some cases, the output component 515 may be a component of an I/O controller 710 as described with reference to FIG. 7.

The device 505, or various components thereof, may be an example of means for performing various aspects of late real-time packet transmission as described herein. For example, the action response component 520 may include a first timer component 525, a second timer component 530, an evaluation component 535, or any combination thereof. The action response component 520 may be an example of aspects of an action response component 420 as described herein. In some examples, the action response component 520, or various components thereof, may be configured to perform various operations (e.g., receiving, obtaining, monitoring, outputting, transmitting) using or otherwise in cooperation with the input component 510, the output component 515, or both. For example, the action response component 520 may receive information from the input component 510, send information to the output component 515, or be integrated in combination with the input component 510, the output component 515, or both to obtain information, output information, or perform various other operations as described herein.

The action response component 520 may support wireless communications in accordance with examples as disclosed herein. The first timer component 525 is capable of, configured to, or operable to support a means for starting a first timer based on entry of a packet into a buffer at the wireless device, where the first timer is associated with a valid transmission window for the packet. The second timer component 530 is capable of, configured to, or operable to support a means for starting a second timer based on expiration of the first timer while the packet is still in the buffer, where the second timer is associated with a pre-discard state of the packet. The evaluation component 535 is capable of, configured to, or operable to support a means for participating in an evaluation of whether any candidate scheduled transmission exists for transmission, during pendency of the second timer, of at least a portion of the packet, where participation in the evaluation is based on the packet being in the pre-discard state.

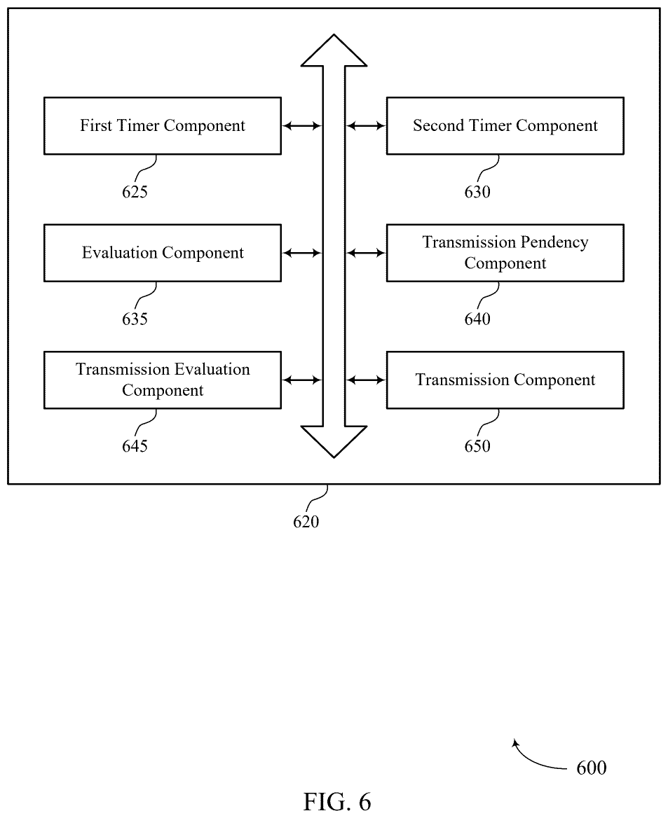

FIG. 6 shows a block diagram 600 of an action response component 620 that supports late real-time packet transmission in accordance with one or more aspects of the present disclosure. The action response component 620 may be an example of aspects of an action response component 420, an action response component 520, or both, as described herein. The action response component 620, or various components thereof, may be an example of means for performing various aspects of late real-time packet transmission as described herein. For example, the action response component 620 may include a first timer component 625, a second timer component 630, an evaluation component 635, a transmission pendency component 640, a transmission evaluation component 645, a transmission component 650, or any combination thereof. Each of these components, or components or subcomponents thereof (e.g., one or more processors, one or more memories), may communicate, directly or indirectly, with one another (e.g., via one or more buses).

The action response component 620 may support wireless communications in accordance with examples as disclosed herein. The first timer component 625 is capable of, configured to, or operable to support a means for starting a first timer based on entry of a packet into a buffer at the wireless device, where the first timer is associated with a valid transmission window for the packet. The second timer component 630 is capable of, configured to, or operable to support a means for starting a second timer based on expiration of the first timer while the packet is still in the buffer, where the second timer is associated with a pre-discard state of the packet. The evaluation component 635 is capable of, configured to, or operable to support a means for participating in an evaluation of whether any candidate scheduled transmission exists for transmission, during pendency of the second timer, of at least a portion of the packet, where participation in the evaluation is based on the packet being in the pre-discard state.

In some examples, the packet includes real-time packet data and. In some examples, the valid transmission window is a duration of time for transmission of real-time packet data.

In some examples, to support participating in the evaluation, the transmission pendency component 640 is capable of, configured to, or operable to support a means for determining that a first candidate scheduled transmission exists during the pendency of the second timer. In some examples, to support participating in the evaluation, the transmission evaluation component 645 is capable of, configured to, or operable to support a means for evaluating the first candidate scheduled transmission to determine whether the first candidate scheduled transmission is capable of transmission of at least the portion of the packet.

In some examples, to support evaluating the first candidate scheduled transmission, the transmission evaluation component 645 is capable of, configured to, or operable to support a means for determining whether the first candidate scheduled transmission includes a quantity of padding bits that are replaceable by at least the portion of the packet.

In some examples, the transmission component 650 is capable of, configured to, or operable to support a means for transmitting at least the portion of the packet as part of the first candidate scheduled transmission based on the quantity of padding bits in the first candidate scheduled transmission being sufficient for replacement by at least the portion of the packet.

In some examples, to support transmitting at least a portion of the packet as part of the first candidate scheduled transmission, the transmission component 650 is capable of, configured to, or operable to support a means for transmitting a second portion of the packet as part of a second candidate scheduled transmission based on a quantity of padding bits in the second candidate scheduled transmission being sufficient for replacement by at least the second portion of the packet, where the second portion of the packet is in the pre-discard state.

In some examples, transmitting at least the portion of the packet includes transmitting a set of multiple packets based on the quantity of padding bits in the first candidate scheduled transmission being sufficient for replacement by the set of multiple packets. In some examples, the set of multiple packets are in the pre-discard state.

In some examples, the packet is one of a set of multiple packets in the pre-discard state, and the transmission component 650 is capable of, configured to, or operable to support a means for selecting at least the portion of the packet from the set of multiple packets for transmission in the first candidate scheduled transmission is based on a packet status, a packet identifier, a packet priority, a network condition, one or more configurations, available memory of the wireless device, or a combination thereof.

In some examples, a payload of the first candidate scheduled transmission has a same DRB) priority as the packet. In some examples, a PDCP sequence number of at least the portion of the packet is assigned so as to avoid sequence number gaps or out-of-order sequence numbers in the first candidate scheduled transmission and subsequent scheduled transmissions.

In some examples, the transmission evaluation component 645 is capable of, configured to, or operable to support a means for ignoring one or more MAC routing restrictions during transmission of at least the portion of the packet with the first candidate scheduled transmission.

In some examples, the one or more MAC routing restrictions include a subcarrier spacing restriction, a maximum PUSCH allowed duration restriction, a configured grant type restriction, or an allowed cell restriction.

In some examples, to support determining whether the first candidate scheduled transmission includes the quantity of padding bits that are replaceable by at least the portion of the packet, the transmission evaluation component 645 is capable of, configured to, or operable to support a means for determining a priority between the packet and any pre-emptive RLC acknowledged mode (AM) retransmission messages that are available to replace the quantity of padding bits.

In some examples, the transmission evaluation component 645 is capable of, configured to, or operable to support a means for discarding the packet based on expiration of the second timer.

In some examples, during the pendency of the second timer, the packet is not included in a buffer status report transmitted by the wireless device.

In some examples, the transmission evaluation component 645 is capable of, configured to, or operable to support a means for receiving a configuration including a first duration of the first timer and a second duration of the second timer.

In some examples, the transmission evaluation component 645 is capable of, configured to, or operable to support a means for adapting the second duration of the second timer based on real-time traffic type, network conditions, one or more configurations, available memory of the wireless device, or a combination thereof.

FIG. 7 shows a diagram of a system 700 including a device 705 that supports late real-time packet transmission in accordance with one or more aspects of the present disclosure. The device 705 may be an example of or include components of a device 405, a device 505, or a wireless device as described herein. The device 705 may include components for bi-directional voice and data communications including components for transmitting and receiving communications, such as an action response component 720, an I/O controller, such as an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor. In some examples, a user may interact with the device 705 via the I/O controller 710 or via hardware components controlled by the I/O controller 710.

The database controller 715 may manage data storage and processing in a database 735. The database 735 may be external to the device 705, temporarily or permanently connected to the device 705, or a data storage component of the device 705. In some cases, a user may interact with the database controller 715. In some other cases, the database controller 715 may operate automatically without user interaction. The database 735 may be an example of a persistent data store, a single database, a distributed database, multiple distributed databases, a database management system, or an emergency backup database.

Memory 725 may include random-access memory (RAM) and ROM. The memory 725 may store computer-readable, computer-executable software including instructions that, when executed, cause the processor to perform various functions described herein. In some cases, the memory 725 may contain, among other things, a BIOS which may control basic hardware or software operation such as the interaction with peripheral components or devices.

The processor 730 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 730 may be configured to operate a memory array using a memory controller. In some other cases, a memory controller may be integrated into the processor 730. The processor 730 may be configured to execute computer-readable instructions stored in memory 725 to perform various functions (e.g., functions or tasks supporting late real-time packet transmission).

The action response component 720 may support wireless communications in accordance with examples as disclosed herein. For example, the action response component 720 is capable of, configured to, or operable to support a means for starting a first timer based on entry of a packet into a buffer at the wireless device, where the first timer is associated with a valid transmission window for the packet. The action response component 720 is capable of, configured to, or operable to support a means for starting a second timer based on expiration of the first timer while the packet is still in the buffer, where the second timer is associated with a pre-discard state of the packet. The action response component 720 is capable of, configured to, or operable to support a means for participating in an evaluation of whether any candidate scheduled transmission exists for transmission, during pendency of the second timer, of at least a portion of the packet, where participation in the evaluation is based on the packet being in the pre-discard state.

By including or configuring the action response component 720 in accordance with examples as described herein, the device 705 may support techniques for late real-time packet transmission, which may result in various advantages, such as improved communication reliability, reduced latency, improved user experience related to reduced processing, reduced power consumption, more efficient utilization of communication resources, improved coordination between devices, longer battery life, improved utilization of processing capability, etc.

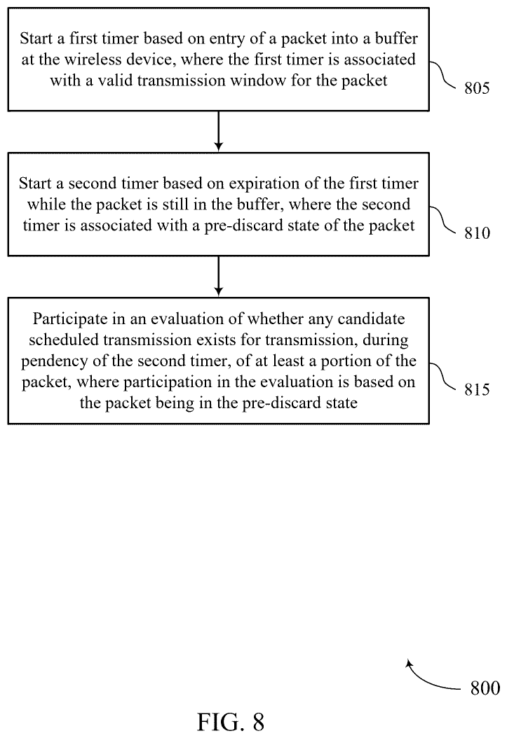

FIG. 8 shows a flowchart illustrating a method 800 that supports late real-time packet transmission in accordance with one or more aspects of the present disclosure. The operations of the method 800 may be implemented by a wireless device or its components as described herein. For example, the operations of the method 800 may be performed by a wireless device as described with reference to FIGS. 1 through 7. In some examples, a wireless device may execute a set of instructions to control the functional elements of the wireless device to perform the described functions. Additionally, or alternatively, the wireless device may perform aspects of the described functions using special-purpose hardware.

At 805, the method may include starting a first timer based on entry of a packet into a buffer at the wireless device, where the first timer is associated with a valid transmission window for the packet. The operations of 805 may be performed in accordance with examples as disclosed herein. In some examples, aspects of the operations of 805 may be performed by a first timer component 625 as described with reference to FIG. 6.

At 810, the method may include starting a second timer based on expiration of the first timer while the packet is still in the buffer, where the second timer is associated with a pre-discard state of the packet. The operations of 810 may be performed in accordance with examples as disclosed herein. In some examples, aspects of the operations of 810 may be performed by a second timer component 630 as described with reference to FIG. 6.

At 815, the method may include participating in an evaluation of whether any candidate scheduled transmission exists for transmission, during pendency of the second timer, of at least a portion of the packet, where participation in the evaluation is based on the packet being in the pre-discard state. The operations of 815 may be performed in accordance with examples as disclosed herein. In some examples, aspects of the operations of 815 may be performed by an evaluation component 635 as described with reference to FIG. 6.

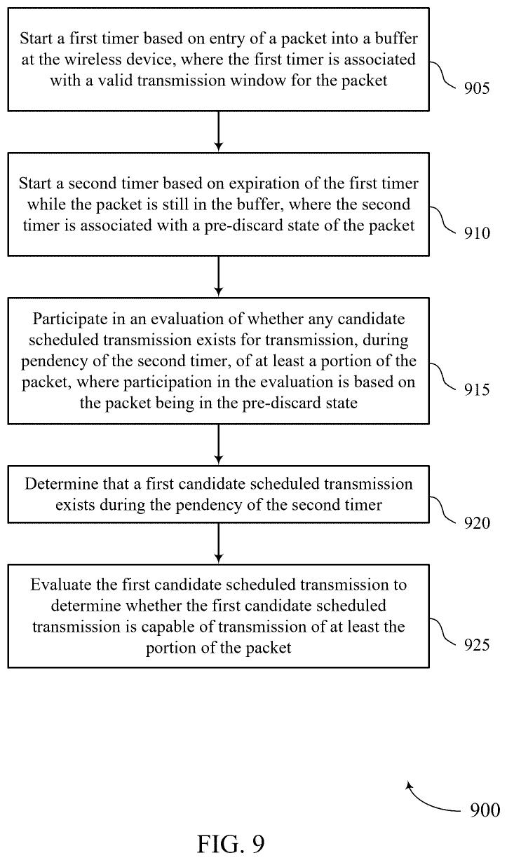

FIG. 9 shows a flowchart illustrating a method 900 that supports late real-time packet transmission in accordance with one or more aspects of the present disclosure. The operations of the method 900 may be implemented by a wireless device or its components as described herein. For example, the operations of the method 900 may be performed by a wireless device as described with reference to FIGS. 1 through 7. In some examples, a wireless device may execute a set of instructions to control the functional elements of the wireless device to perform the described functions. Additionally, or alternatively, the wireless device may perform aspects of the described functions using special-purpose hardware.

At 905, the method may include starting a first timer based on entry of a packet into a buffer at the wireless device, where the first timer is associated with a valid transmission window for the packet. The operations of 905 may be performed in accordance with examples as disclosed herein. In some examples, aspects of the operations of 905 may be performed by a first timer component 625 as described with reference to FIG. 6.

At 910, the method may include starting a second timer based on expiration of the first timer while the packet is still in the buffer, where the second timer is associated with a pre-discard state of the packet. The operations of 910 may be performed in accordance with examples as disclosed herein. In some examples, aspects of the operations of 910 may be performed by a second timer component 630 as described with reference to FIG. 6.

At 915, the method may include participating in an evaluation of whether any candidate scheduled transmission exists for transmission, during pendency of the second timer, of at least a portion of the packet, where participation in the evaluation is based on the packet being in the pre-discard state. The operations of 915 may be performed in accordance with examples as disclosed herein. In some examples, aspects of the operations of 915 may be performed by an evaluation component 635 as described with reference to FIG. 6.

At 920, the method may include determining that a first candidate scheduled transmission exists during the pendency of the second timer. The operations of 920 may be performed in accordance with examples as disclosed herein. In some examples, aspects of the operations of 920 may be performed by a transmission pendency component 640 as described with reference to FIG. 6.

At 925, the method may include evaluating the first candidate scheduled transmission to determine whether the first candidate scheduled transmission is capable of transmission of at least the portion of the packet. The operations of 925 may be performed in accordance with examples as disclosed herein. In some examples, aspects of the operations of 925 may be performed by a transmission evaluation component 645 as described with reference to FIG. 6.

The following provides an overview of aspects of the present disclosure:

Aspect 1: A method for wireless communications at a wireless device, comprising: starting a first timer based on entry of a packet into a buffer at the wireless device, wherein the first timer is associated with a valid transmission window for the packet; starting a second timer based on expiration of the first timer while the packet is still in the buffer, wherein the second timer is associated with a pre-discard state of the packet; and participating in an evaluation of whether any candidate scheduled transmission exists for transmission, during pendency of the second timer, of at least a portion of the packet, wherein participation in the evaluation is based at least in part on the packet being in the pre-discard state.

Aspect 2: The method of aspect 1, wherein the packet includes real-time packet data and the valid transmission window is a duration of time for transmission of real-time packet data.

Aspect 3: The method of any of aspects 1 through 2, wherein participating in the evaluation comprises: determining that a first candidate scheduled transmission exists during the pendency of the second timer; and evaluating the first candidate scheduled transmission to determine whether the first candidate scheduled transmission is capable of transmission of at least the portion of the packet.

Aspect 4: The method of aspect 3, wherein evaluating the first candidate scheduled transmission comprises: determining whether the first candidate scheduled transmission includes a quantity of padding bits that are replaceable by at least the portion of the packet.

Aspect 5: The method of aspect 4, further comprising: transmitting at least the portion of the packet as part of the first candidate scheduled transmission based at least in part on the quantity of padding bits in the first candidate scheduled transmission being sufficient for replacement by at least the portion of the packet.

Aspect 6: The method of aspect 5, wherein transmitting at least a portion of the packet as part of the first candidate scheduled transmission further comprises: transmitting a second portion of the packet as part of a second candidate scheduled transmission based at least in part on a quantity of padding bits in the second candidate scheduled transmission being sufficient for replacement by at least the second portion of the packet, wherein the second portion of the packet is in the pre-discard state.

Aspect 7: The method of any of aspects 5 through 6, wherein transmitting at least the portion of the packet comprises transmitting a plurality of packets based at least in part on the quantity of padding bits in the first candidate scheduled transmission being sufficient for replacement by the plurality of packets, the plurality of packets are in the pre-discard state.

Aspect 8: The method of any of aspects 5 through 7, wherein the packet is one of a plurality of packets in the pre-discard state, the method further comprising: selecting at least the portion of the packet from the plurality of packets for transmission in the first candidate scheduled transmission is based at least in part on a packet status, a packet identifier, a packet priority, a network condition, one or more configurations, available memory of the wireless device, or a combination thereof.

Aspect 9: The method of any of aspects 5 through 8, wherein a payload of the first candidate scheduled transmission has a same DRB priority as the packet.

Aspect 10: The method of any of aspects 5 through 9, wherein a PDCP sequence number of at least the portion of the packet is assigned so as to avoid sequence number gaps or out-of-order sequence numbers in the first candidate scheduled transmission and subsequent scheduled transmissions.

Aspect 11: The method of any of aspects 5 through 10, further comprising: ignoring one or more MAC routing restrictions during transmission of at least the portion of the packet with the first candidate scheduled transmission.

Aspect 12: The method of aspect 11, wherein the one or more MAC routing restrictions include a subcarrier spacing restriction, a maximum PUSCH allowed duration restriction, a configured grant Type restriction, or an allowed cell restriction.

Aspect 13: The method of any of aspects 4 through 12, wherein determining whether the first candidate scheduled transmission includes the quantity of padding bits that are replaceable by at least the portion of the packet comprises: determining a priority between the packet and any pre-emptive RLC AM retransmission messages that are available to replace the quantity of padding bits.

Aspect 14: The method of any of aspects 1 through 13, further comprising: discarding the packet based at least in part on expiration of the second timer.

Aspect 15: The method of any of aspects 1 through 14, wherein during the pendency of the second timer, the packet is not included in a buffer status report transmitted by the wireless device.

Aspect 16: The method of any of aspects 1 through 15, further comprising: receiving a configuration comprising a first duration of the first timer and a second duration of the second timer.

Aspect 17: The method of aspect 16, further comprising: adapting the second duration of the second timer based at least in part on real-time traffic type, network conditions, one or more configurations, available memory of the wireless device, or a combination thereof.

Aspect 18: A wireless device for wireless communications, comprising one or more memories storing processor-executable code, and one or more processors coupled with the one or more memories and individually or collectively operable to execute the code to cause the wireless device to perform a method of any of aspects 1 through 17.

Aspect 19: A wireless device for wireless communications, comprising at least one means for performing a method of any of aspects 1 through 17.

Aspect 20: A non-transitory computer-readable medium storing code for wireless communications, the code comprising instructions executable by one or more processors to perform a method of any of aspects 1 through 17.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
start a first timer based on entry of a packet into a buffer at the wireless device, wherein the first timer is associated with a valid transmission window for the packet;
start a second timer based on expiration of the first timer while the packet is still in the buffer, wherein the second timer is associated with a pre-discard state of the packet; and
participate in an evaluation of whether any candidate scheduled transmission exists for transmission, during pendency of the second timer, of at least a portion of the packet, wherein participation in the evaluation is based at least in part on the packet being in the pre-discard state.

2. The wireless device of claim 1, wherein the packet includes real-time packet data and the valid transmission window is a duration of time for transmission of the real-time packet data.

3. The wireless device of claim 1, wherein, to participate in the evaluation, the one or more processors are individually or collectively operable to execute the code to cause the wireless device to:
determine that a first candidate scheduled transmission exists during the pendency of the second timer; and
evaluate the first candidate scheduled transmission to determine whether the first candidate scheduled transmission is capable of transmission of at least the portion of the packet.

4. The wireless device of claim 3, wherein, to evaluate the first candidate scheduled transmission, the one or more processors are individually or collectively operable to execute the code to cause the wireless device to:
determine whether the first candidate scheduled transmission includes a quantity of padding bits that are replaceable by at least the portion of the packet.

5. The wireless device of claim 4, wherein the one or more processors are individually or collectively further operable to execute the code to cause the wireless device to:
transmit at least the portion of the packet as part of the first candidate scheduled transmission based at least in part on the quantity of padding bits in the first candidate scheduled transmission being sufficient for replacement by at least the portion of the packet.

6. The wireless device of claim 5, wherein, to transmit at least the portion of the packet as part of the first candidate scheduled transmission, the one or more processors are individually or collectively further operable to execute the code to cause the wireless device to:
transmit a second portion of the packet as part of a second candidate scheduled transmission based at least in part on a quantity of padding bits in the second candidate scheduled transmission being sufficient for replacement by at least the second portion of the packet, wherein the second portion of the packet is in the pre-discard state.

7. The wireless device of claim 5, wherein:
transmitting at least the portion of the packet comprises transmitting a plurality of packets based at least in part on the quantity of padding bits in the first candidate scheduled transmission being sufficient for replacement by the plurality of packets, wherein the plurality of packets is in the pre-discard state.

8. The wireless device of claim 5, wherein the packet is one of a plurality of packets in the pre-discard state, and the one or more processors are individually or collectively further operable to execute the code to cause the wireless device to:
select at least the portion of the packet from the plurality of packets for transmission in the first candidate scheduled transmission is based at least in part on a packet status, a packet identifier, a packet priority, a network condition, one or more configurations, available memory of the wireless device, or a combination thereof.

9. The wireless device of claim 5, wherein a payload of the first candidate scheduled transmission has a same data radio bearer (DRB) priority as the packet.

10. The wireless device of claim 5, wherein a packet data convergence protocol (PDCP) sequence number of at least the portion of the packet is assigned so as to avoid sequence number gaps or out-of-order sequence numbers in the first candidate scheduled transmission and subsequent scheduled transmissions.

11. The wireless device of claim 5, wherein the one or more processors are individually or collectively further operable to execute the code to cause the wireless device to:
ignore one or more medium access control (MAC) routing restrictions during transmission of at least the portion of the packet with the first candidate scheduled transmission.

12. The wireless device of claim 11, wherein the one or more MAC routing restrictions include a subcarrier spacing restriction, a maximum physical uplink shared channel (PUSCH) allowed duration restriction, a configured grant Type restriction, or an allowed cell restriction.

13. The wireless device of claim 4, wherein, to determine whether the first candidate scheduled transmission includes the quantity of padding bits that are replaceable by at least the portion of the packet, the one or more processors are individually or collectively operable to execute the code to cause the wireless device to:
determine a priority between the packet and any pre-emptive radio link control (RLC) acknowledged mode (AM) retransmission messages that are available to replace the quantity of padding bits.

14. The wireless device of claim 1, wherein the one or more processors are individually or collectively further operable to execute the code to cause the wireless device to:
discard the packet based at least in part on expiration of the second timer.

15. The wireless device of claim 1, wherein during the pendency of the second timer, the packet is not included in a buffer status report transmitted by the wireless device.

16. The wireless device of claim 1, wherein the one or more processors are individually or collectively further operable to execute the code to cause the wireless device to:
receive a configuration comprising a first duration of the first timer and a second duration of the second timer.

17. The wireless device of claim 16, wherein the one or more processors are individually or collectively further operable to execute the code to cause the wireless device to:
adapt the second duration of the second timer based at least in part on real-time traffic type, network conditions, one or more configurations, available memory of the wireless device, or a combination thereof.

18. A method for wireless communications at a wireless device, comprising:
starting a first timer based on entry of a packet into a buffer at the wireless device, wherein the first timer is associated with a valid transmission window for the packet;
starting a second timer based on expiration of the first timer while the packet is still in the buffer, wherein the second timer is associated with a pre-discard state of the packet; and
participating in an evaluation of whether any candidate scheduled transmission exists for transmission, during pendency of the second timer, of at least a portion of the packet, wherein participation in the evaluation is based at least in part on the packet being in the pre-discard state.

19. The method of claim 18, further comprising:
discarding the packet based at least in part on expiration of the second timer.

20. A wireless device for wireless communications, comprising:
means for starting a first timer based on entry of a packet into a buffer at the wireless device, wherein the first timer is associated with a valid transmission window for the packet;
means for starting a second timer based on expiration of the first timer while the packet is still in the buffer, wherein the second timer is associated with a pre-discard state of the packet; and
means for participating in an evaluation of whether any candidate scheduled transmission exists for transmission, during pendency of the second timer, of at least a portion of the packet, wherein participation in the evaluation is based at least in part on the packet being in the pre-discard state.
